(19) United States
(12) Patent Application Publication
(10) Pub. No.: US 2022/0019923 A1
(43) Pub. Date: Jan. 20, 2022

(54) SUPERVISED INFINITE BINARY MATRIX GENERATION DEVICE, METHOD, AND PROGRAM

(71) Applicant: NEC Corporation, Minato-ku, Tokyo (JP)

(72) Inventor: Hiroshi TAMANO, Tokyo (JP)

(73) Assignee: NEC Corporation, Minato-ku, Tokyo (JP)

(21) Appl. No.: 17/293,611

(22) PCT Filed: Nov. 15, 2018
(86) PCT No.: PCT/JP2018/042257

§ 371 Date: May 13, 2021

(51) Int. Cl. G06N 7/00; G06N 20/00

(52) U.S. Cl. CPC G06N 7/005; G06N 20/00

(57) ABSTRACT

There is provided a supervised infinite binary matrix generation device that generates a binary matrix allowing humans to understand the meaning of each dimension. An input unit 71 inputs a dictionary matrix obtained by collecting binary row vectors of a plurality of types of patterns, a binary selection matrix having one “1” in each row, and a binary training matrix. The posterior probability calculation unit 72 calculates posterior probabilities of the dictionary matrix and the selection matrix, based on a generation process in which the dictionary matrix is generated by the Indian buffet process, a generation process in which the selection matrix is generated by the Dirichlet process, and a generation process in which the training matrix is probabilistically or deterministically generated from a part of the product of the dictionary matrix and the selection matrix.

### TECHNICAL FIELD

The present invention relates to a supervised infinite binary matrix generation device, a supervised infinite binary matrix generation method, and a supervised infinite binary matrix generation program.

### BACKGROUND ART

NPL 1 discloses the conversion of a multidimensional real-valued vector to a binary (0 or 1) feature vector. In addition, NPL 2 discloses the link prediction of a graph.

The Indian buffet process (IBP), which is a stochastic process of generating an infinite binary matrix, is used for the above conversion from a multidimensional real-valued vector to a binary feature vector, link prediction of a graph, and the like. With the Indian buffet process, by considering a model capable of generating an infinite binary matrix, it is possible to automatically estimate a binary matrix having an appropriate size depending on data without determining the size of the binary matrix in advance.

### CITATION LIST

### Non Patent Literature

NPL 1: Thomas L. Griffiths, Zoubin Ghahramani, “Infinite Latent Feature Models and the Indian Buffet Process”, Advances in Neural Information Processing Systems. 2006.
NPL 2: Kurt T. Miller, Thomas L. Griffiths, Michael I. Jordan, “Nonparametric Latent Feature Models for Link Prediction”, Advances in Neural Information Processing Systems. 2009.

### SUMMARY OF INVENTION

### Technical Problem

Estimating a binary matrix has a problem that it is difficult for humans to interpret the estimated binary matrix. For example, with the latent feature model disclosed in NPL 1, a feature vector composed of 0 and 1 is estimated for each data. However, it is very difficult for humans to make meaning of what each dimension of the feature vector means after the estimation.

For the above reason, the present invention provides a supervised infinite binary matrix generation device, a supervised infinite binary matrix generation method, and a supervised infinite binary matrix generation program that generate a binary matrix allowing humans to understand the meaning of each dimension.

### Solution to Problem

A supervised infinite binary matrix generation device according to the present invention includes a data input unit that inputs a dictionary matrix obtained by collecting binary row vectors of a plurality of types of patterns, a binary selection matrix having one “1” in each row, and a binary training matrix, and a posterior probability calculation unit that calculates posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

A supervised infinite binary matrix generation device according to the present invention includes a data input unit that inputs a dictionary matrix obtained by collecting binary row vectors of a plurality of types of patterns, a selection matrix represented by unconstrained binary values, a binary training matrix, and a binary generation target matrix, and a posterior probability calculation unit that calculates posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

A supervised infinite binary matrix generation device according to the present invention includes a data input unit that inputs a dictionary matrix obtained by collecting binary row vectors of a plurality of types of patterns, a selection matrix represented by unconstrained binary values, a binary training matrix, and a binary generation target matrix, and a posterior probability calculation unit that calculates posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

A supervised infinite binary matrix generation method according to the present invention includes performing, by a computer including a data input unit that inputs a dictionary matrix obtained by collecting binary row vectors of a plurality of types of patterns, a binary selection matrix having one “1” in each row, and a binary training matrix, posterior probability calculation processing of calculating posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

A supervised infinite binary matrix generation method according to the present invention includes performing, by a computer including a data input unit that inputs a dictionary matrix obtained by collecting binary row vectors of a plurality of types of patterns, a selection matrix represented by unconstrained binary values, a binary training matrix, and a binary generation target matrix, posterior probability calculation processing of calculating posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

A supervised infinite binary matrix generation method according to the present invention includes performing, by a computer including a data input unit that inputs a dictionary matrix obtained by collecting binary row vectors of a plurality of types of patterns, a selection matrix represented by unconstrained binary values, a binary training matrix, and a binary generation target matrix, posterior probability calculation processing of calculating posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

A supervised infinite binary matrix generation program according to the present invention is a supervised infinite binary matrix generation program to be mounted in a computer including a data input unit that inputs a dictionary matrix obtained by collecting binary row vectors of a plurality of types of patterns, a binary selection matrix having one “1” in each row, and a binary training matrix, and causes the computer to execute posterior probability calculation processing of calculating posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

A supervised infinite binary matrix generation program according to the present invention is a supervised infinite binary matrix generation program to be mounted in a computer including a data input unit that inputs a dictionary matrix obtained by collecting binary row vectors of a plurality of types of patterns, a selection matrix represented by unconstrained binary values, a binary training matrix, and a binary generation target matrix, and causes the computer to execute performing posterior probability calculation processing of calculating posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

A supervised infinite binary matrix generation program according to the present invention is a supervised infinite binary matrix generation program to be mounted in a computer including a data input unit that inputs a dictionary matrix obtained by collecting binary row vectors of a plurality of types of patterns, a selection matrix represented by unconstrained binary values, a binary training matrix, and a binary generation target matrix, and causes the computer to execute performing posterior probability calculation processing of calculating posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

### Advantageous Effects of Invention

According to the present invention, it is possible for humans to understand the meaning of each dimension of a binary matrix.

### BRIEF DESCRIPTION OF DRAWINGS

FIG. 1 It depicts is a block diagram schematically showing an example of a functional configuration of a supervised infinite binary matrix generation device in a first exemplary embodiment of the present invention.

FIG. 2 It depicts a diagram schematically showing a probabilistic model in the first exemplary embodiment.

FIG. 3 It depicts a flowchart showing an operation in the first exemplary embodiment of the present invention.

FIG. 4 It depicts is a block diagram schematically showing an example of a functional configuration of a supervised infinite binary matrix generation device in a second exemplary embodiment of the present invention.

FIG. 5 It depicts a diagram schematically showing a probabilistic model in the second exemplary embodiment.

FIG. 6 It depicts a flowchart showing an operation in the second exemplary embodiment of the present invention.

FIG. 7 It depicts a flowchart showing the operation in the second exemplary embodiment of the present invention.

FIG. 8 It depicts a diagram schematically showing a probabilistic model when β=1.

FIG. 9 It depicts a diagram schematically showing a process of data generation in an example of the present invention.

FIG. 10 It depicts a block diagram showing a configuration example of a skill estimation device.

FIG. 11 It depicts a block diagram schematically showing a configuration example of a computer according to the supervised infinite binary matrix generation device in each exemplary embodiment of the present invention.

FIG. 12 It depicts a block diagram showing an outline of a supervised infinite binary matrix generation device according to the present invention.

### DESCRIPTION OF EMBODIMENTS

Hereinafter, exemplary embodiments of the present invention will be described with reference to the drawings. In each of the following exemplary embodiments, the symbol “W (backslash)” means “other than”.

### First Exemplary Embodiment

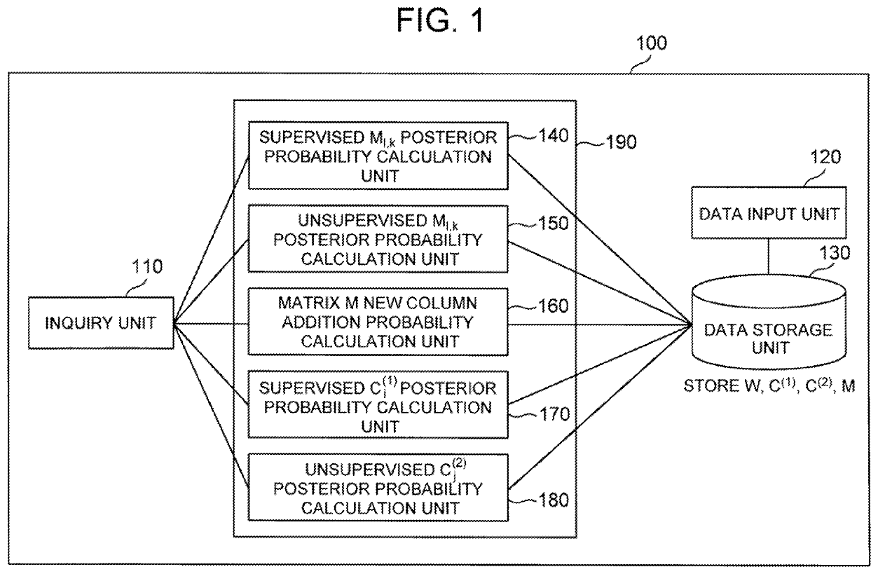

FIG. 1 is a block diagram schematically showing an example of a functional configuration of a supervised infinite binary matrix generation device in a first exemplary embodiment of the present invention. A supervised infinite binary matrix generation device 100 in the first exemplary embodiment includes an inquiry unit 110, a data input unit 120, a data storage unit 130, and a posterior probability calculation unit 190. The posterior probability calculation unit 190 includes a supervised M_{l,k} posterior probability calculation unit 140, an unsupervised M_{l,k} posterior probability calculation unit 150, a matrix M new column addition probability calculation unit 160, and a supervised Cᵢ⁽¹⁾ posterior probability calculation unit 170, and an unsupervised Cⱼ⁽²⁾ posterior probability calculation unit 180.

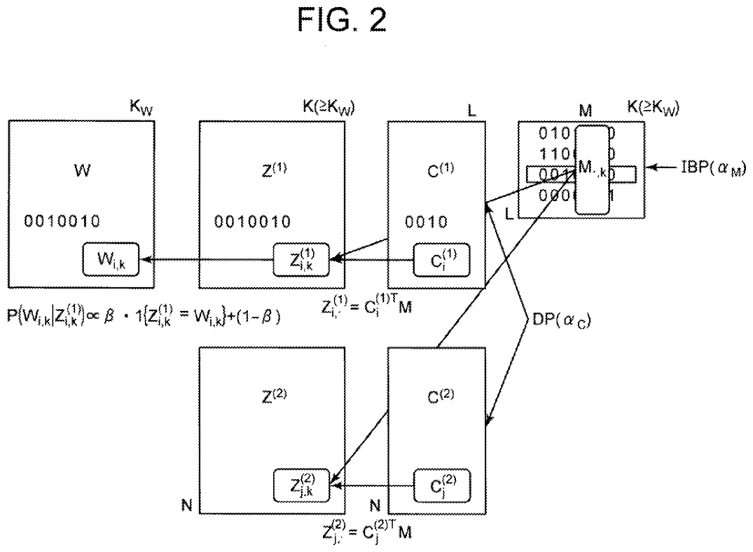

FIG. 2 is a diagram schematically showing a probabilistic model in the first exemplary embodiment. The supervised infinite binary matrix generation device 100 calculates and outputs each posterior probability according to the probabilistic model shown in FIG. 2.

Matrices Z⁽¹⁾Z⁽²⁾ represent binary matrices to be generated. Note that, when a matrix Z is mentioned, the matrix Z represents a matrix in which these two matrices Z⁽¹⁾Z⁽²⁾ are vertically connected.

A matrix W represents training data (a training matrix) corresponding to the matrix Z⁽¹⁾.

Matrices M, C⁽¹⁾C⁽²⁾ represent binary matrices for generating the matrix Z. Note that, when a matrix C is mentioned, the matrix C represents a matrix in which these two matrices C⁽¹⁾C⁽²⁾ are vertically connected.

The matrix M is generated by the Indian buffet process (IBP) with α_{M} as a parameter. The matrix C is generated by the Dirichlet process (DP). Each row vector of the matrix C is a vector (One Hot vector) in which one of the elements is 1 and the others are 0.

The matrix Z is deterministically generated by the product of the matrix C and the matrix M. Each row of the matrix Z is the part where 1 in the corresponding row of the matrix C holds, and is generated by selecting a row of the matrix M.

Finally, the matrix W is probabilistically generated from the matrix Z⁽¹⁾ by P(W_{i,k}|Z_{i,k}⁽¹⁾)∝β·1{(Z_{i,k}⁽¹⁾≠W_{i,k}}+(1−β).

The supervised infinite binary matrix generation device 100 assumes the above binary matrix generation model and calculates a posterior probability of each element of the matrices C, M.

Next, each constituent element is described.

The inquiry unit 110 sorts requests for various calculations.

The data input unit 120 inputs information necessary for various calculations. The information necessary for calculations differs depending on various calculation requests, and the data input unit 120 inputs the matrices W, C, M excluding the calculation target parts of posterior probabilities. The matrix M is a dictionary matrix obtained by collecting binary row vectors of a plurality of types of patterns. The matrix C is a binary selection matrix having one “1” in each row. The matrix W is a binary training matrix.

The data input unit 120 is implemented by, for example, a data input device such as a data reading device (for example, an optical disk drive) that reads data from a data recording medium. In this case, the data reading device (the data input unit 120) is only required to read the matrices W, C, M recorded on a data recording medium. The above data reading device is an example of the data input device used as the data input unit 120, and the data input unit 120 may be another data input device. For example, the data input unit 120 may be a communication interface that receives data from another device.

The posterior probability calculation unit 190 calculates posterior probabilities of the dictionary matrix and the selection matrix, based on a generation process in which the dictionary matrix is generated by the Indian buffet process, a generation process in which the selection matrix is generated by the Dirichlet process, and a generation process in which the training matrix is probabilistically generated from a part of the product of the dictionary matrix and the selection matrix.

The data storage unit 130 is a storage device that stores the information input by the data input unit 120 and supplies the information for various calculations.

The various calculation requests are described below.

The supervised M_{l,k} posterior probability calculation unit 140 calculates the posterior probability of supervised M_{l,k} by the following Expression (1). Supervised M_{l,k} refers to the part “k≤K_{w}” and is a matrix of the part corresponding to training data W.

$$\begin{matrix}[ Expression 1 ] & \\ P ( {M}_{l , k} \vert {M}_{\backslash l , k} , {C}^{( 1 )} , {C}^{( 2 )} , W ) ∝ P ( {M}_{l , k} \vert {M}_{\backslash l , k} ) \cdot {\prod }_{i} {P ( {W}_{i , k} \vert {C}_{i}^{( 1 )} , {M}_{, k} )}^{1 \{ {C}_{i}^{( 1 )} = l \}} = \frac{{m}_{k}^{\backslash l , k}}{L} \cdot {\prod }_{i} {( 1 - β )}^{1 \{ {W}_{i , k} \neq {M}_{l , k} ⋀ {C}_{i}^{( 1 )} = l \}} & ( 1 )\end{matrix}$$

The unsupervised M_{l,k} posterior probability calculation unit 150 calculates the posterior probability of unsupervised M_{l,k} by the following Expression (2). Unsupervised M_{l,k} refers to the part “k>K_{w}” and is a matrix of the part not corresponding to the training data W.

$$\begin{matrix}[ Expression 2 ] & \\ P ( {M}_{l , k} \vert {M}_{∖ l , k} , {C}^{( 1 )} , {C}^{( 2 )} , W ) ∝ P ( {M}_{l , k} \vert {M}_{∖ l , k} ) = \frac{{m}_{k}^{\backslash l , k}}{L} & ( 2 )\end{matrix}$$

The matrix M new column addition probability calculation unit 160 calculates the probability of each number of columns to be added to the matrix M by the following Expression (3).

$$\begin{matrix}[ Expression 3 ] & \\ m \text{∼} P o ( \frac{{α}_{M}}{L} ) & ( 3 )\end{matrix}$$

The supervised Cᵢ⁽¹⁾ posterior probability calculation unit 170 calculates the posterior probability of Cᵢ⁽¹⁾ by the following Expression (4). Cᵢ⁽¹⁾ represents the i-th row of the matrix C⁽¹⁾. The probability calculation of adding a new column to the matrix C requires the addition of a new row to the matrix M. To add a new row to the matrix M, the new row to be added is generated by probabilistic sampling by Expressions (1) and (2).

$$\begin{matrix}[ Expression 4 ] & \\ P ( {C}_{i}^{( 1 )} = l \vert M , {C}_{\backslash i}^{( 1 )} , {C}^{( 2 )} , W ) ∝ P ( {W}_{i ,} \vert {C}_{i}^{( 1 )} , M ) \cdot P ( {C}_{i}^{( 1 )} \vert {C}_{\backslash i}^{( 1 )} , {C}^{( 2 )} ) = \{ \begin{matrix}\frac{{n}_{l}^{\backslash i}}{N - 1 + {α}_{C}} \cdot {\prod }_{k} {( 1 - β )}^{1 ( {W}_{i , k} \neq {M}_{l , k} \}} \\ \frac{{α}_{C}}{N - 1 + {α}_{C}} \cdot {\prod }_{k} {( 1 - β )}^{1 \{ {W}_{i , k} \neq {M}_{new - l , k} \}}\end{matrix} & ( 4 )\end{matrix}$$

The unsupervised Cⱼ⁽²⁾ posterior probability calculation unit 180 calculates the posterior probability of Cⱼ⁽²⁾ by the following Expression (5). Cⱼ⁽²⁾ represents the j-th row of the matrix C⁽²⁾. To add a new row to the matrix M, the new row to be added is generated by probabilistic sampling by Expressions (1) and (2).

$$\begin{matrix}[ Expression 5 ] & \\ P ( {C}_{j}^{( 2 )} = l \vert M , {C}^{( 1 )} , {C}_{\backslash j}^{( 2 )} , W ) ∝ P ( {C}_{j}^{( 2 )} \vert {C}^{( 1 )} , {C}_{\backslash j}^{( 2 )} ) = \{ \begin{matrix}\frac{{n}_{l}^{\backslash i}}{N - 1 + {α}_{C}} \\ \frac{{α}_{C}}{N - 1 + {α}_{C}}\end{matrix} & ( 5 )\end{matrix}$$

The posterior probability calculation unit 190 including the supervised M_{l,k} posterior probability calculation unit 140, the unsupervised M_{l,k} posterior probability calculation unit 150, the matrix M new column addition probability calculation unit 160, the supervised Cᵢ⁽¹⁾ posterior probability calculation unit 170, and the unsupervised Cⱼ⁽²⁾ posterior probability calculation unit 180, and the inquiry unit 110 are implemented by, for example, a central processing unit (CPU) of a computer operating according to a supervised infinite binary matrix generation program. For example, the CPU loads the supervised infinite binary matrix generation program from a program recording medium such as a computer program storage device or the like to operate, according to the program, as the posterior probability calculation unit 190 including the supervised M_{l,k} posterior probability calculation unit 140, the unsupervised M_{l,k} posterior probability calculation unit 150, the matrix M new column addition probability calculation unit 160, the supervised Cᵢ⁽¹⁾ posterior probability calculation unit 170, and the unsupervised Cⱼ⁽²⁾ posterior probability calculation unit 180, and the inquiry unit 110.

The data storage unit 130 is implemented by, for example, a storage device included in a computer.

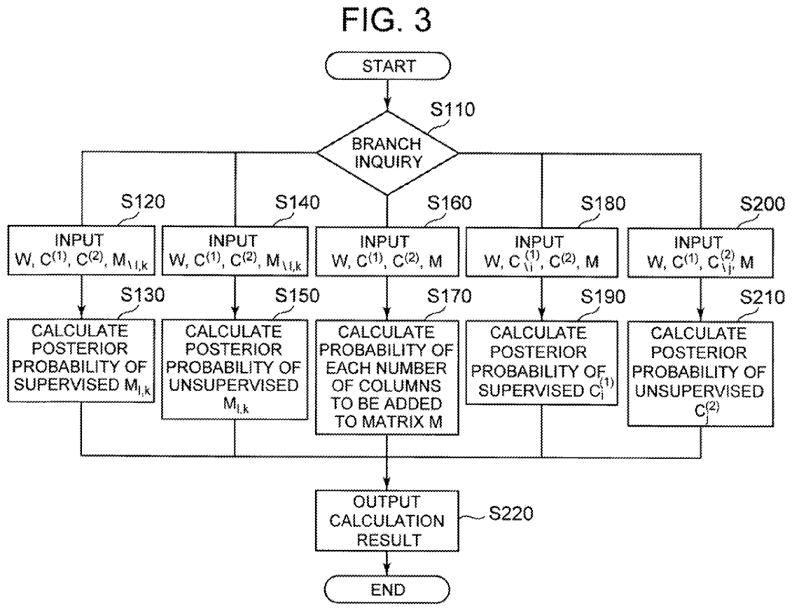

Next, the operation is described. FIG. 3 is a flowchart showing the operation in the first exemplary embodiment of the present invention.

First, processing is branched for each calculation target (step S110). In other words, the inquiry unit 110 selects a calculation target.

When the posterior probability of supervised M_{l,k} is selected in step S110, the data input unit 120 inputs the data other than M_{l,k} (step S120). That is, the data input unit 120 inputs W, C⁽¹⁾, C⁽²⁾, [symbol] ₖ.

Next, the supervised M_{l,k} posterior probability calculation unit 140 calculates the posterior probability of supervised M_{l,k} (step S130). Then, the supervised M_{l,k} posterior probability calculation unit 140 outputs the calculation result (here, the posterior probability of supervised M_{l,k}) (step S220).

When the posterior probability of unsupervised M_{l,k} is selected in step S110, the data input unit 120 inputs the data other than M_{l,k} (step S140). That is, the data input unit 120 inputs W, C⁽¹⁾, C⁽²⁾, [symbol] ₖ.

Next, the unsupervised M_{l,k} posterior probability calculation unit 150 calculates the posterior probability of unsupervised M_{l,k} (step S150). Then, the unsupervised M_{l,k} posterior probability calculation unit 150 outputs the calculation result (here, the posterior probability of unsupervised M_{l,k}) (step S220).

When the new addition probability of the matrix M is selected in step S110, the data input unit 120 inputs the matrices W, C, M (step S160).

Next, the matrix M new column addition probability calculation unit 160 calculates the probability of each number of columns to be added to the matrix M (step S170). Then, the matrix M new column addition probability calculation unit 160 outputs the calculation result (here, the probability of each number of columns to be added to the matrix M) (step S220).

When the posterior probability of supervised Cᵢ⁽¹⁾ is selected in step S110, the data input unit 120 inputs the data other than Cᵢ⁽¹⁾ (step S180). That is, the data input unit 120 inputs W, [symbol] ⁽¹⁾, C⁽²⁾, M.

Next, the supervised Cᵢ⁽¹⁾ posterior probability calculation unit 170 calculates the posterior probability of Cᵢ⁽¹⁾ (step S190). Then, the supervised Cᵢ⁽¹⁾ posterior probability calculation unit 170 outputs the calculation result (here, the posterior probability of Cᵢ⁽¹⁾) (step S220).

When the posterior probability of unsupervised Cⱼ⁽²⁾ is selected in step S110, the data input unit 120 inputs the data other than Cⱼ⁽²⁾ (step S200). That is, the data input unit 120 inputs W, C⁽¹⁾, [symbol] ⁽²⁾, M.

Next, the unsupervised Cⱼ⁽²⁾ posterior probability calculation unit 180 calculates the posterior probability of Cⱼ⁽²⁾ (step S210). Then, the unsupervised Cⱼ⁽²⁾ posterior probability calculation unit 180 outputs the calculation result (here, the posterior probability of Cⱼ⁽²⁾) (step S220).

Next, the effect of the present exemplary embodiment is described. In the present exemplary embodiment, the matrix W can be input as training data for certain data in generation of an infinite binary matrix. Since each column of training data (training matrix W) is given a meaning in advance by a human, the human can understand the meaning of each dimension (for example, each column) after estimating the binary matrix. That is, it is not necessary for humans to think about the meaning of each column.

Next, a modification of the first exemplary embodiment is described.

The matrix W may be assumed to be probabilistically generated from the matrix Z⁽¹⁾ by P(W_{i,k}|Z_{i,k}⁽¹⁾=1)∝β₁·1{W_{i,k}=1}+(1−β₁), P(W_{i,k}|Z_{i,k}⁽¹⁾=0)∝β₀·1{W_{i,k}=1}+(1−β₀).

In this case, the right-hand side of the above Expression (1) is replaced with the following Expression (6), and the right-hand side of the above Expression (4) is replaced with the following Expression (7).

$$\begin{matrix}[ Expression 6 ] & \\ \{ \begin{matrix}\frac{{m}_{k}^{\backslash l , k}}{L} \cdot {\prod }_{i} {( 1 - {β}_{1} )}^{1 \{ {W}_{i , k} = 0 ⋀ {C}_{i}^{( 1 )} = l \}} & when {M}_{l , k} = 1 \\ \frac{{m}_{k}^{\backslash l , k}}{L} \cdot {\prod }_{i} {( 1 - {β}_{0} )}^{1 \{ {W}_{i , k} = 1 ⋀ {C}_{i}^{( 1 )} = l \}} & when {M}_{l , k} = 0\end{matrix} & ( 6 ) \\ [ Expression 7 ] & \\ \{ \begin{matrix}\frac{{n}_{l}^{\backslash i}}{N - 1 + {α}_{C}} \cdot {\prod }_{k} {( 1 - {β}_{1} )}^{1 \{ {W}_{i , k} = 0 \}} & when {M}_{l , k} = 1 \\ \frac{{n}_{l}^{\backslash i}}{N - 1 + {α}_{C}} \cdot {\prod }_{k} {( 1 - {β}_{0} )}^{1 \{ {W}_{i , k} = 0 \}} & when {M}_{l , k} = 0 \\ \frac{{α}_{C}}{N - 1 + {α}_{C}} \cdot {\prod }_{k} {( 1 - {β}_{1} )}^{1 \{ {W}_{i , k} \neq {M}_{new - l , k} \}} & when {M}_{l , k} = 1 \\ \frac{{α}_{C}}{N - 1 + {α}_{C}} \cdot {\prod }_{k} {( 1 - {β}_{0} )}^{1 \{ {W}_{i , k} \neq {M}_{new - l , k} \}} & when {M}_{l , k} = 0\end{matrix} & ( 7 )\end{matrix}$$

That is, the supervised M_{l,k} posterior probability calculation unit 140 calculates the posterior probability of supervised M_{l,k} by the expression in which the right-hand side of Expression (1) is replaced with Expression (6).

In addition, the supervised Cᵢ⁽¹⁾ posterior probability calculation unit 170 calculates the posterior probability of Cᵢ⁽¹⁾ by the expression in which the right-hand side of Expression (4) is replaced with Expression (7).

In this modification, it can be said that the posterior probability calculation unit 190 calculates the posterior probabilities of the dictionary matrix and the selection matrix, assuming that the training matrix is generated using different probability distributions depending on whether each element of the matrix of the product of the dictionary matrix and the selection matrix is 1 or 0.

According to the above modification, in the mistake of training data created by humans, the probability that a position that should be originally 0 is mistaken for 1 and the probability that a position that should be originally 1 is mistaken for 0 can be handled separately. In other words, when 1 holds in training data, the position is almost certainly 1, and when there is a slight possibility that a position is 1 although 0 holds, by setting β₁ to a value close to 1 such as 0.99 and setting β₀ to a value smaller than 1 such as 0.7, it is possible to estimate that a position where 1 holds in training data is almost certainly 1 and to estimate a position where 0 holds in the training data taking into account the likelihood of the data.

Next, another modification of the first exemplary embodiment is described. In the first exemplary embodiment, it may be assumed that the training data has no error. In this case, the training matrix is deterministically generated. That is, the posterior probability calculation unit 190 calculates posterior probabilities of the dictionary matrix and the selection matrix, based on a generation process in which the dictionary matrix is generated by the Indian buffet process, a generation process in which the selection matrix is generated by the Dirichlet process, and a generation process in which the training matrix is deterministically generated from a part of the product of the dictionary matrix and the selection matrix.

### Second Exemplary Embodiment

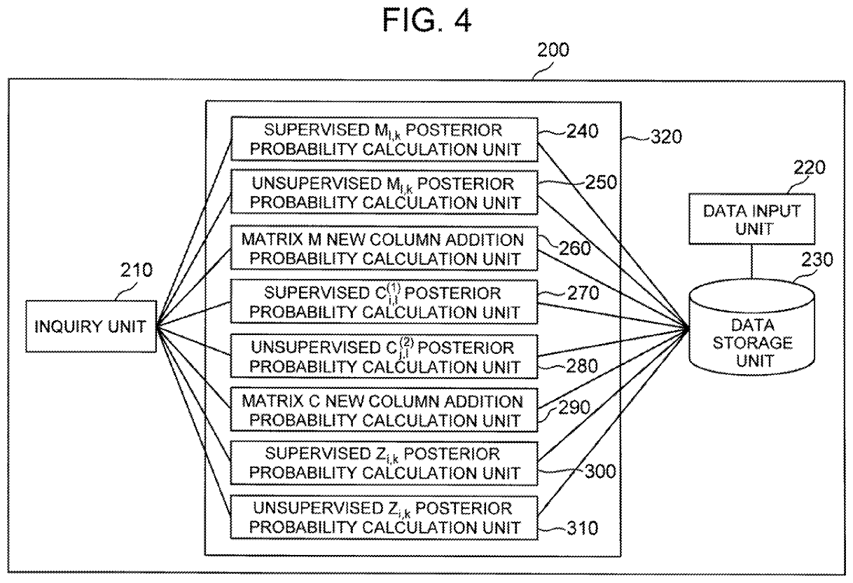

FIG. 4 is a block diagram schematically showing an example of a functional configuration of a supervised infinite binary matrix generation device in a second exemplary embodiment of the present invention. A supervised infinite binary matrix generation device 200 in the second exemplary embodiment includes an inquiry unit 210, a data input unit 220, a data storage unit 230, and a posterior probability calculation unit 320. The posterior probability calculation unit 320 includes a supervised M_{l,k} posterior probability calculation unit 240, an unsupervised M_{l,k} posterior probability calculation unit 250, a matrix M new column addition probability calculation unit 260, and a supervised C_{i,l}⁽¹⁾ posterior probability calculation unit 270, an unsupervised C_{j,l}⁽²⁾ posterior probability calculation unit 280, a matrix C new column addition probability calculation unit 290, a supervised Z_{i,k} posterior probability calculation unit 300, and an unsupervised Z_{i,k} posterior probability calculation unit 310.

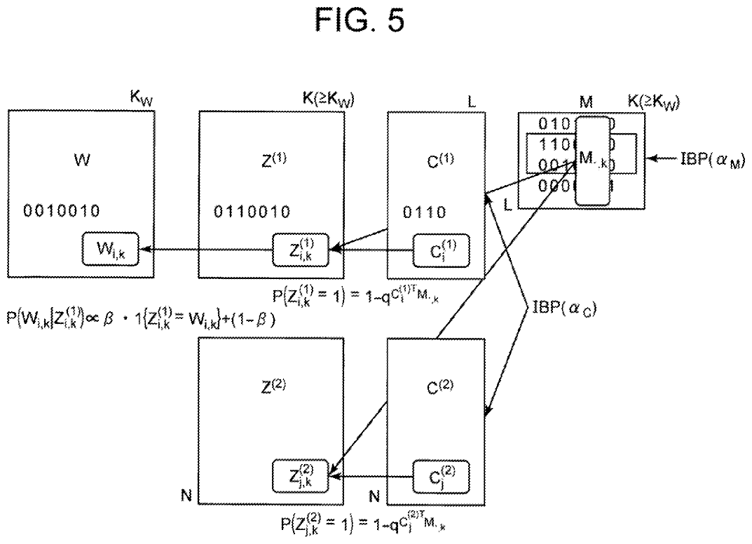

FIG. 5 is a diagram schematically showing a probabilistic model in the second exemplary embodiment. The supervised infinite binary matrix generation device 200 calculates and outputs each posterior probability according to the probabilistic model shown in FIG. 5. The second exemplary embodiment is different from the first exemplary embodiment in that a matrix C is generated by the Indian buffet process with ac as a parameter instead of the Dirichlet process and that a matrix Z is not deterministically generated but is probabilistically generated according to P(Z_{i,k}⁽¹⁾=1)=1−q\hat{ }(Cᵢ^{T}M·ₖ).

Next, each constituent element is described.

The inquiry unit 210 sorts requests for various calculations.

The data input unit 220 inputs information necessary for various calculations. The information necessary for calculations differs depending on various calculation requests, and the data input unit 220 inputs matrices Z, W, C, M excluding the calculation target parts of the posterior probabilities. The matrix M is a dictionary matrix obtained by collecting binary row vectors of a plurality of types of patterns. The matrix C is a selection matrix represented by unconstrained binary values. The matrix W is a binary training matrix. The matrix Z is a binary generation target matrix.

The data input unit 220 is implemented by a data input device. This is similar to the data input unit 120 in the first exemplary embodiment, and the description thereof is omitted.

The posterior probability calculation unit 320 calculates the posterior probabilities of the dictionary matrix, the selection matrix, and the generation target matrix, assuming that the selection matrix is generated by the Indian buffet process, that the generation target matrix is probabilistically generated from the product of the dictionary matrix and the selection matrix, and that the training matrix is probabilistically generated from a part of the generation target matrix.

The data storage unit 230 is a storage device that stores the information input by the data input unit 220 and supplies the information for various calculations.

The various calculation requests are described below.

The supervised M_{l,k} posterior probability calculation unit 240 calculates the posterior probability of supervised M_{l,k} by the following Expression (8).

$$\begin{matrix}[ Expression 8 ] & \\ P ( {M}_{l , k} \vert {M}_{\backslash l , k} , {C}^{( 1 )} , {C}^{( 2 )} , W ) ∝ P ( {M}_{l , k} \vert {M}_{\backslash l , k} ) \cdot P ( Z \vert C , M ) = \frac{{m}_{k}^{\backslash l , k}}{L} \cdot {\prod }_{i} {( 1 - {q}^{{C}_{i ,}^{T} M {,}_{k}} )}^{{Z}_{i , k}} {q}^{{C}_{i}^{T} , M {,}_{k} ( 1 - {Z}_{i , k} )} & ( 8 )\end{matrix}$$

The unsupervised M_{l,k} posterior probability calculation unit 250 calculates the posterior probability of unsupervised M_{l,k} by Expression (8).

In the second exemplary embodiment, both the expression for calculating the posterior probability of supervised M_{l,k} and the expression for calculating the posterior probability of unsupervised M_{l,k} are Expression (8), and the operation of the supervised M_{l,k} posterior probability calculation unit 240 and the operation of the unsupervised M_{l,k} posterior probability calculation unit 250 are similar to each other.

The matrix M new column addition probability calculation unit 260 calculates the probability corresponding to the number of additional columns by the following Expression (9). In other words, the matrix M new column addition probability calculation unit 260 calculates the probability of each number of columns to be added to the matrix M by the following Expression (9).

$$\begin{matrix}[ Expression 9 ] & \\ m \text{∼} P o ( \frac{{α}_{M}}{L} ) & ( 9 )\end{matrix}$$

The supervised C_{i,l}⁽¹⁾ posterior probability calculation unit 270 calculates the posterior probability of C_{i,l}⁽¹⁾ by the following Expression (10).

$$\begin{matrix}[ Expression 10 ] & \\ P ( {C}_{i , l} \vert M , {C}_{\backslash i , l} , W , Z ) ∝ P ( {C}_{i , l} \vert {C}_{\backslash i , l} ) {\prod }_{k} P ( {Z}_{i , k} \vert {C}_{i ,} , M {,}_{k} ) = \frac{c {m}_{l}^{\backslash i , l}}{N} \cdot {\prod }_{k} {( 1 - {q}^{{C}_{i ,}^{T} M {,}_{k}} )}^{{Z}_{i , k}^{( 1 )}} \cdot {q}^{{C}_{i ,}^{T} M {,}_{k} ( 1 - {Z}_{i , k}^{( 1 )} )} & ( 10 )\end{matrix}$$

The unsupervised C_{j,l}⁽²⁾ posterior probability calculation unit 280 calculates the posterior probability of C_{j,l}⁽²⁾ by the following Expression (11).

$$\begin{matrix}[ Expression 11 ] & \\ P ( {C}_{j , l} \vert M , {C}_{\backslash j , l} , W , Z ) ∝ P ( {C}_{j , l} \vert {C}_{\backslash j , l} ) {\prod }_{k} P ( {Z}_{j , k} \vert {C}_{j ;} , M {,}_{k} ) = \frac{c {m}_{l}^{\backslash j , l}}{N} \cdot {\prod }_{k} {( 1 - {q}^{{C}_{j ,}^{T} M {,}_{k}} )}^{{Z}_{j , k}^{( 1 )}} \cdot {q}^{{C}_{j ;}^{T} M {,}_{k} ( 1 - {Z}_{j , k}^{( 1 )} )} & ( 11 )\end{matrix}$$

The matrix C new column addition probability calculation unit 290 calculates the probability corresponding to the number of additional columns by the following Expression (12). In other words, the matrix C new column addition probability calculation unit 290 calculates the probability of each number of columns to be added to the matrix C by the following Expression (12).

$$\begin{matrix}[ Expression 12 ] & \\ c m \text{∼} P o ( \frac{{α}_{C}}{N} ) \cdot {\prod }_{k} p ( {Z}_{i , k} \vert {C}_{i ,} , {M}_{, k} ) Po ( \frac{{α}_{C}}{N} ) \cdot {\prod }_{k} {( 1 - {q}^{{C}_{i ;}^{T} M {,}_{k}} )}^{{Z}_{i , k}^{( 1 )}} \cdot {q}^{{C}_{i ;}^{T} M {,}_{k} ( 1 - {Z}_{i , k}^{( 1 )} )} & ( 12 )\end{matrix}$$

The supervised Z_{i,k} posterior probability calculation unit 300 calculates the posterior probability of supervised Z_{i,k} by the following Expression (13). Supervised Z_{i,k} refers to the part “k≤K_{w}” and is a matrix of the part corresponding to the training data W.

$$\begin{matrix}[ Expression 13 ] & \\ P ( {Z}_{i , k}^{( 1 )} \vert W , {Z}_{\backslash i , k}^{( 1 )} , {Z}^{( 2 )} , C , M ) ∝ P ( {Z}^{( 1 )} \vert {C}^{( 1 )} , M ) P ( {W}_{i , k} \vert {Z}_{i , k}^{( 1 )} ) ∝ {( 1 - {q}^{{C}_{i}^{( 1 ) T} M {,}_{k}} )}^{{Z}_{i , k}^{( 1 )}} {{q}^{{C}_{i}^{( 1 ) T} {M}_{, k} ( 1 - {Z}_{i , k}^{( 1 )} )} ( 1 - β )}^{1 \{ {Z}_{i , k}^{( 1 )} \neq {W}_{i , k} \}} & ( 13 )\end{matrix}$$

The unsupervised Z_{i,k} posterior probability calculation unit 310 calculates the posterior probability of unsupervised Z_{i,k} by the following Expression (14). Unsupervised Z_{i,k} refers to the part “k>K_{w}” and is a matrix of the part not corresponding to the training data W.

$$\begin{matrix}[ Expression 14 ] & \\ P ( {Z}_{i , k}^{( 1 )} \vert W , {Z}_{\backslash i , k}^{( 1 )} , {Z}^{( 2 )} , C , M ) ∝ P ( {Z}^{( 1 )} \vert {C}^{( 1 )} , M ) ∝ {( 1 - {q}^{{C}_{i}^{( 1 ) T} M {,}_{k}} )}^{{Z}_{i , k}^{( 1 )}} {q}^{{C}_{i}^{( 1 ) T} M {,}_{k} ( 1 - {Z}_{i , k}^{( 1 )} )} & ( 14 )\end{matrix}$$

The posterior probability calculation unit 320 including the supervised M_{l,k} posterior probability calculation unit 240, the unsupervised M_{l,k} posterior probability calculation unit 250, the matrix M new column addition probability calculation unit 260, the supervised C_{i,l}⁽¹⁾ posterior probability calculation unit 270, the unsupervised C_{j,l}⁽²⁾ posterior probability calculation unit 280, the matrix C new column addition probability calculation unit 290, the supervised Z_{i,k} posterior probability calculation unit 300, and the unsupervised Z_{i,k} posterior probability calculation unit 310, and the inquiry unit 210 are implemented by, for example, a CPU of a computer operating according to a supervised infinite binary matrix generation program. For example, the CPU loads the supervised infinite binary matrix generation program from a program recording medium such as a computer program storage device or the like to operate, according to the program, as the posterior probability calculation unit 320 including the supervised M_{l,k} posterior probability calculation unit 240, the unsupervised M_{l,k} posterior probability calculation unit 250, the matrix M new column addition probability calculation unit 260, the supervised C_{i,l}⁽¹⁾ posterior probability calculation unit 270, the unsupervised C_{j,l}⁽²⁾ posterior probability calculation unit 280, the matrix C new column addition probability calculation unit 290, the supervised Z_{i,k} posterior probability calculation unit 300, and the unsupervised Z_{i,k} posterior probability calculation unit 310, and the inquiry unit 210.

The data storage unit 230 is implemented by, for example, a storage device included in a computer.

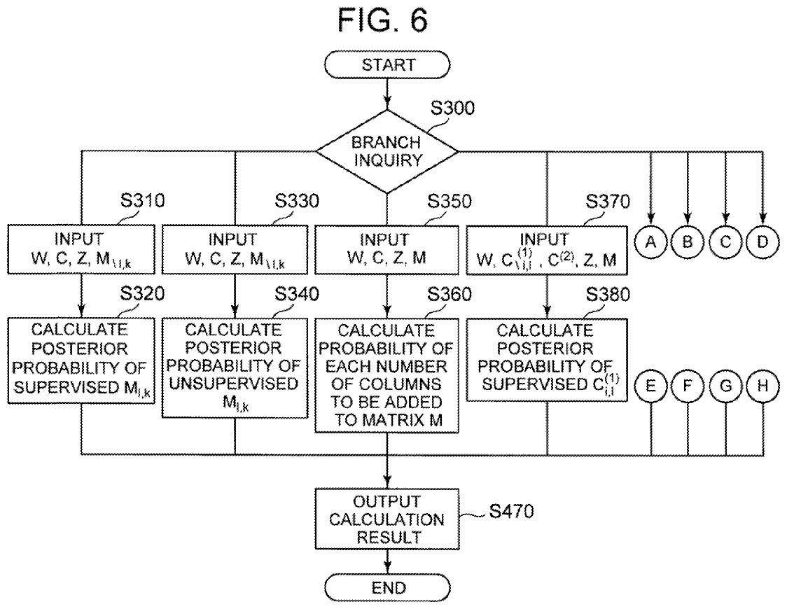

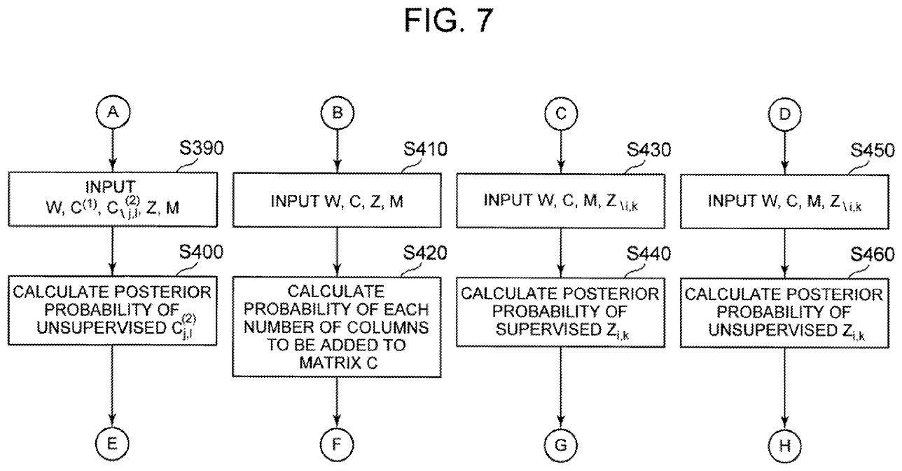

Next, the operation is described. FIGS. 6 and 7 are flowcharts showing the operation in the second exemplary embodiment of the present invention.

First, processing is branched for each calculation target (step S300). In other words, the inquiry unit 210 selects a calculation target.

When the posterior probability of supervised M_{l,k} is selected in step S300, the data input unit 220 inputs the data other than M_{l,k} (step S310). That is, the data input unit 220 inputs W, C, Z, [symbol] ₖ.

Next, the supervised M_{l,k} posterior probability calculation unit 240 calculates the posterior probability of supervised M_{l,k} (step S320). Then, the supervised M_{l,k} posterior probability calculation unit 240 outputs the calculation result (here, the posterior probability of supervised M_{l,k}) (step S470).

When the posterior probability of unsupervised M_{l,k} is selected in step S300, the data input unit 220 inputs the data other than M_{l,k} (step S330). That is, the data input unit 220 inputs W, C, Z, [symbol] ₖ.

Next, the unsupervised M_{l,k} posterior probability calculation unit 250 calculates the posterior probability of unsupervised M_{l,k} (step S340). Then, the unsupervised M_{l,k} posterior probability calculation unit 250 outputs the calculation result (here, the posterior probability of unsupervised M_{l,k}) (step S470).

As already described, both the expression for calculating the posterior probability of supervised M_{l,k} and the expression for calculating the posterior probability of unsupervised M_{l,k} are Expression (8), and the operation of the supervised M_{l,k} posterior probability calculation unit 240 and the operation of the unsupervised M_{l,k} posterior probability calculation unit 250 are similar to each other.

When the new addition probability of the matrix M is selected in step S300, the data input unit 220 inputs the matrices W, C, Z, M (step S350).

Next, the matrix M new column addition probability calculation unit 260 calculates the probability of each number of columns to be added to the matrix M (step S360). Then, the matrix M new column addition probability calculation unit 260 outputs the calculation result (here, the probability of each number of columns to be added to the matrix M) (step S470).

When the posterior probability of supervised C_{i,l}⁽¹⁾ is selected in step S300, the data input unit 220 inputs the data other than C_{i,l}⁽¹⁾ (step S370). That is, the data input unit 220 inputs W, [symbol] l⁽¹⁾, C⁽²⁾, Z, M.

Next, the supervised C_{i,l}⁽¹⁾ posterior probability calculation unit 270 calculates the posterior probability of C_{i,l}⁽¹⁾ (step S380). Then, the supervised C_{i,l}⁽¹⁾ posterior probability calculation unit 270 outputs the calculation result (here, the posterior probability C_{i,l}⁽¹⁾) (step S470).

When the posterior probability of unsupervised C_{j,l}⁽²⁾ is selected in step S300, the data input unit 220 inputs the data other than C_{j,l}⁽²⁾ (step S390 (see FIG. 7)). That is, the data input unit 220 inputs W, C⁽¹⁾, [symbol] l⁽²⁾, Z, M.

Next, the unsupervised C_{j,l}⁽²⁾ posterior probability calculation unit 280 calculates the posterior probability of C_{j,l}⁽²⁾ (step S400). Then, the unsupervised C_{j,l}⁽²⁾ posterior probability calculation unit 280 outputs the calculation result (here, the posterior probability of C_{j,l}⁽²⁾) (step S470).

When the new addition probability of the matrix C is selected in step S300, the data input unit 220 inputs the matrices W, C, Z, M (step S410 (see FIG. 7)).

Next, the matrix C new column addition probability calculation unit 290 calculates the probability of each number of columns to be added to the matrix C (step S420). Then, the matrix C new column addition probability calculation unit 290 outputs the calculation result (here, the probability of each number of columns to be added to the matrix C) (step S470).

When the posterior probability of supervised Z_{i,k} is selected in step S300, the data input unit 220 inputs the data other than Z_{i,k} (step S430 (see FIG. 7)). That is, the data input unit 220 inputs W, C, M, [symbol] ₖ.

Next, the supervised Z_{i,k} posterior probability calculation unit 300 calculates the posterior probability of supervised Z_{i,k} (step S440). Then, the supervised Z_{i,k} posterior probability calculation unit 300 outputs the calculation result (here, the posterior probability of supervised Z_{i,k}) (step S470).

When the posterior probability of unsupervised Z_{i,k} is selected in step S300, the data input unit 220 inputs the data other than Z_{i,k} (step S450 (see FIG. 7)). That is, the data input unit 220 inputs W, C, M, [symbol] ₖ.

Next, the unsupervised Z_{i,k} posterior probability calculation unit 310 calculates the posterior probability of unsupervised Z_{i,k} (step S460). Then, the unsupervised Z_{i,k} posterior probability calculation unit 310 outputs the calculation result (here, the posterior probability of unsupervised Z_{i,k}) (step S470).

Next, the effect of the present exemplary embodiment is described. As shown in FIG. 5 since the matrix C is generated by the Indian buffet process, each row of the matrix C is not a One Hot expression, and 1 holds at a plurality of positions in the present exemplary embodiment. Thus, since each row of the matrix Z can be represented by a combination of a plurality of rows of matrix M, and Z is probabilistically generated, it is possible to fit more complicated data.

Next, a modification of the second exemplary embodiment is described.

The matrix W may be assumed to be probabilistically generated from the matrix Z⁽¹⁾ by P(W_{i,k}|Z_{i,k}⁽¹⁾=1)∝β₁·1{W_{i,k}=1}+(1−β₁), P(W_{i,k}|Z_{i,k}⁽¹⁾=0)∝β₀·1{W_{i,k}=1}+(1−β₀).

In this case, the right-hand side of the above Expression (13) is replaced with Expression (15) shown below.

$$\begin{matrix}[ Expression 15 ] & \\ \{ \begin{matrix}{( 1 - {q}^{{C}_{i}^{( 1 ) T} M {,}_{k}} )}^{{Z}_{i , k}^{( 1 )}} {{q}^{{C}_{i}^{( 1 ) T} M {,}_{k} ( 1 - {Z}_{l , k}^{( 1 )} )} ( 1 - {β}_{1} )}^{1 \{ {W}_{i , k} = 0 \}} & when {Z}_{i , k} = 1 \\ {( 1 - {q}^{{C}_{i}^{( 1 ) T} M {,}_{k}} )}^{{Z}_{i , k}^{( 1 )}} {{q}^{{C}_{i}^{( 1 ) T} M {,}_{k} ( 1 - {Z}_{i , k}^{( 1 )} )} ( 1 - {β}_{0} )}^{1 \{ {W}_{i , k} = 1 \}} & when {Z}_{i , k} = 0\end{matrix} & ( 15 )\end{matrix}$$

That is, the supervised Z_{i,k} posterior probability calculation unit 300 calculates the posterior probability of supervised Z_{i,k} by the expression in which the right-hand side of Expression (13) is replaced with Expression (15).

In this modification, it can be said that the posterior probability calculation unit 320 calculates the posterior probabilities of the dictionary matrix, the selection matrix, and the generation target matrix, assuming that the training matrix is generated using different probability distributions depending on whether each element of the generation target matrix is 1 or 0.

The effect of the modification of the second exemplary embodiment is similar to the effect of the modification of the first exemplary embodiment.

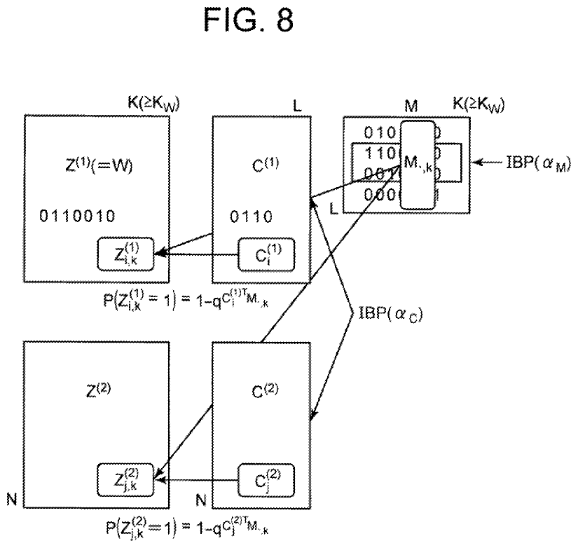

Next, another modification of the second exemplary embodiment is described. In the second exemplary embodiment, it may be assumed that β=1 and that the training data has no error. When β=1, W=Z⁽¹⁾. The probabilistic model when it is assumed that the training data has no error (when β=1) can be expressed as shown in FIG. 8. In this case, if the training data is put in Z⁽¹⁾, W is unnecessary. In this case, it can be said that Z⁽¹⁾ is the training matrix, and that Z⁽²⁾ is the generation target matrix. When the training data is put in Z⁽¹⁾ to perform estimation, the expressions for calculating the posterior probabilities of Z⁽²⁾, C⁽¹⁾, C⁽²⁾, M are similar to those in the second exemplary embodiment. In addition, Z⁽¹⁾ is fixed and does not require the calculation of posterior probability. In this modification, the posterior probability calculation unit 320 calculates the posterior probabilities of the dictionary matrix, the selection matrix, and the generation target matrix, assuming that the selection matrix is generated by the Indian buffet process and that the training matrix and the generation target matrix are probabilistically generated from the product of the dictionary matrix and the selection matrix.

### Example

An example of the present invention will be described. In this example, an example of a skill estimation device that uses the first exemplary embodiment of the present invention and estimates skills required to solve each problem from correct/incorrect log data of a test taken by a student is described.

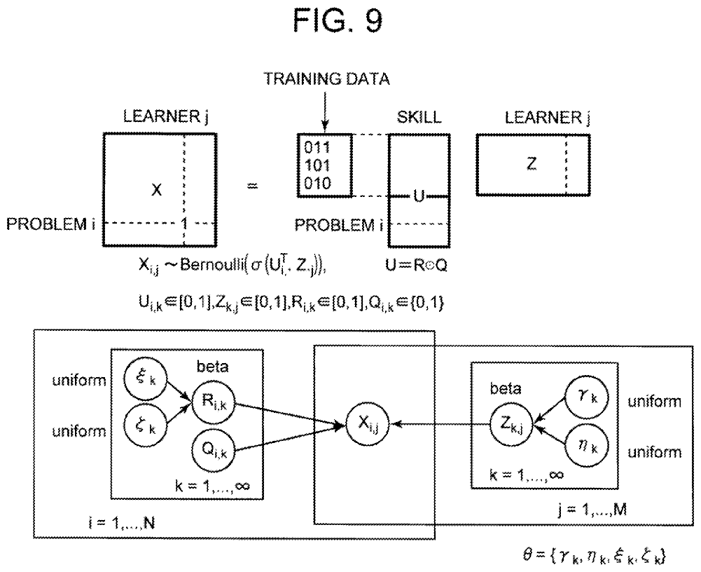

FIG. 9 is a diagram schematically showing the process of data generation. A matrix Xᵢⱼ is a binary matrix indicating whether a student j was able to answer a question i correctly. 0 indicates that the answer was incorrect, and 1 indicates that the answer was correct.

A matrix U is a matrix having values of 0 to 1 indicating how much each skill is required to solve each problem.

A matrix Z is a matrix indicating how much each learner has acquired each skill with 0 to 1.

The matrix U is generated from the product of the matrix R and the matrix Q for each element. The matrix R is a matrix having values of 0 to 1, and the matrix Q is a matrix with a value of 0 or 1. It can be considered that the matrix R is masked by the matrix Q and that the matrix U is created. The matrix Q can be regarded as a correspondence table showing that which skill is required by each problem. In this example, the matrices U, Z, R, Q are estimated, assuming that the matrix Xᵢⱼ is probabilistically generated as shown in the lower graphical model of FIG. 9.

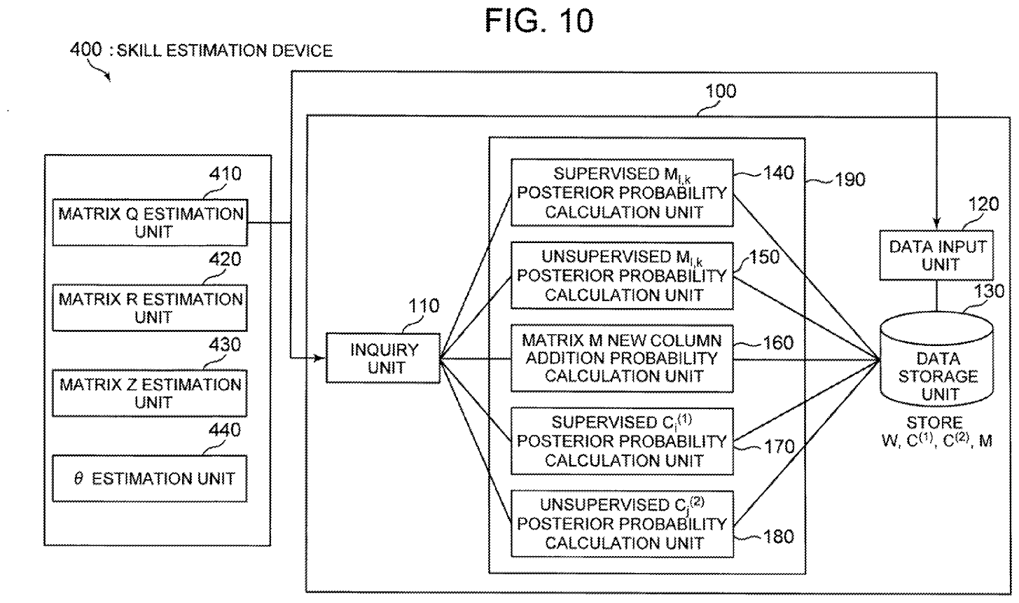

FIG. 10 is a block diagram showing a configuration example of a skill estimation device. A skill estimation device 400 includes a matrix Q estimation unit 410, a matrix R estimation unit 420, a matrix Z estimation unit 430, a θ estimation unit 440, and the supervised infinite binary matrix generation device 100 in the first exemplary embodiment of the present invention. The skill estimation device 400 estimates the matrix Q, the matrix R, the matrix Z, and θ using Gibbs sampling according to the graphical model shown in FIG. 9. The matrix Q estimation unit 410 samples the matrix Q by calling the supervised infinite binary matrix generation device 100 in the first exemplary embodiment. The expressions used for sampling the matrix Q are shown below as Expressions (16) and (17).

$$\begin{matrix}[ Expression 16 ] & \\ P ( {C}_{i} \vert X , Z , R , θ , {C}_{\backslash i} , M , W ) ∝ {\prod }_{j} P ( {X}_{i , j} \vert {R}_{i ;} , {C}_{i ;} , M , {Z}_{;} j ) P ( {C}_{i} \vert {C}_{\backslash i} , M , W ) & ( 16 ) \\ [ Expression 17 ] & \\ P ( {M}_{l , k} \vert X , Z , R , θ , C , {M}_{\backslash i , k} , W ) ∝ {\prod }_{i , j} {P ( {X}_{i , j} \vert {R}_{i ;} , {C}_{i ;} , M , Z {,}_{j} )}^{1 \{ {C}_{i} = l \}} P ( {M}_{l , k} \vert {M}_{\backslash l , k} , C , W ) & ( 17 )\end{matrix}$$

The underlined part in Expression (16) and the underlined part in Expression (17) can be calculated by the supervised infinite binary matrix generation device 100. Since the matrix R estimation unit 420, the matrix Z estimation unit 430, and the θ estimation unit 440 perform calculation by a general Gibbs sampler, description thereof is omitted in this specification.

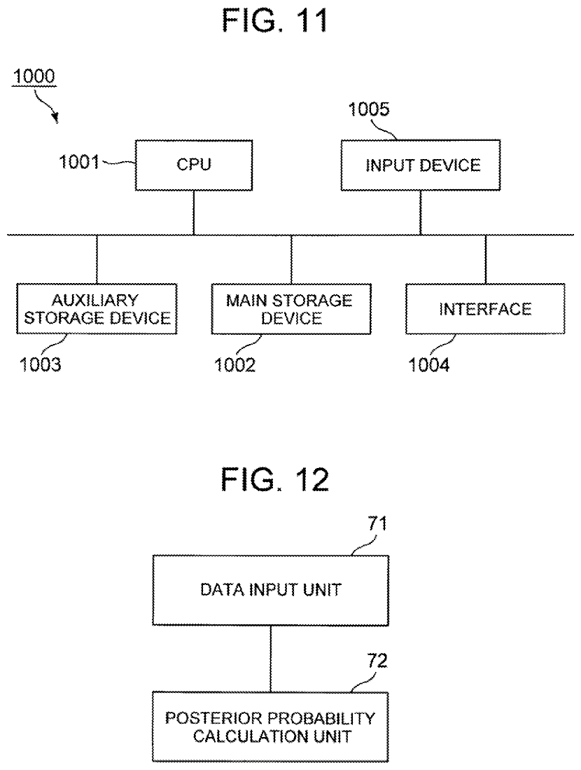

FIG. 11 is a block diagram schematically showing a configuration example of a computer according to the supervised infinite binary matrix generation device in each of the above exemplary embodiments. A computer 1000 includes a CPU 1001, a main storage device 1002, an auxiliary storage device 1003, an interface 1004, and an input device 1005.

The supervised infinite binary matrix generation device in each exemplary embodiment is implemented in the computer 1000, and its operation is stored in the auxiliary storage device 1003 in the form of a supervised infinite binary matrix generation program. The CPU 1001 loads the supervised infinite binary matrix generation program from the auxiliary storage device 1003, develops it in the main storage device 1002, and performs the operations described in the above exemplary embodiments and modifications according to the supervised infinite binary matrix generation program.

The auxiliary storage device 1003 is an example of a non-transitory tangible medium. Other examples of the non-transitory tangible medium include a magnetic disk, a magneto-optical disk, a compact disk read-only memory (CD-ROM), a digital versatile disk read-only memory (DVD-ROM), a semiconductor memory, and the like that are connected via the interface 1004. Alternatively, when the program is distributed to the computer 1000 through a communication line, the computer 1000 receiving the distribution may develop the program in the main storage device 1002 and execute the above processing.

The program may be for implementing a part of the above processing. Furthermore, the program may be a differential program that implements the above processing in combination with another program already stored in the auxiliary storage device 1003.

In addition, a part of or all of the constituent elements may be implemented by a general purpose or dedicated circuitry, a processor, or the like, or a combination thereof. These may be constituted by a single chip or by a plurality of chips connected via a bus. A part of or all of the constituent elements may be implemented by a combination of the above circuitry or the like and a program.

In the case in which a part of or all of the constituent elements are implemented by a plurality of information processing devices, circuitries, or the like, the information processing devices, circuitries, or the like may be arranged in a concentrated manner, or dispersedly. For example, the information processing devices, circuitries, or the like may be implemented as a form in which each is connected via a communication network, such as a client-and-server system, a cloud computing system, or the like.

Next, the outline of the present invention is described. FIG. 12 is a block diagram showing an outline of a supervised infinite binary matrix generation device according to the present invention. The supervised infinite binary matrix generation device according to the present invention includes a data input unit 71 and a posterior probability calculation unit 72. The data input unit 71 corresponds to the data input unit 120 in the first exemplary embodiment or the data input unit 220 in the second exemplary embodiment. The posterior probability calculation unit 72 corresponds to the posterior probability calculation unit 190 in the first exemplary embodiment or the posterior probability calculation unit 320 in the second exemplary embodiment.

The data input unit 71 inputs a dictionary matrix obtained by collecting binary row vectors of a plurality of types of patterns, a binary selection matrix having one “1” in each row, and a binary training matrix.

The posterior probability calculation unit 72 calculates posterior probabilities of the dictionary matrix and the selection matrix, based on a generation process in which the dictionary matrix is generated by the Indian buffet process, a generation process in which the selection matrix is generated by the Dirichlet process, and a generation process in which the training matrix is probabilistically or deterministically generated from a part of the product of the dictionary matrix and the selection matrix.

With such a configuration, it is possible for humans to understand the meaning of each dimension of a binary matrix.

In addition, the data input unit 71 may input a dictionary matrix obtained by collecting binary row vectors of a plurality of types of patterns, a selection matrix represented by unconstrained binary values, a binary training matrix, and a binary generation target matrix.

In this case, the posterior probability calculation unit 72 calculates posterior probabilities of the dictionary matrix, the selection matrix, and the generation target matrix, assuming that the selection matrix is generated by the Indian buffet process, that the generation target matrix is probabilistically generated from the product of the dictionary matrix and the selection matrix, and that the training matrix is probabilistically generated from a part of the generation target matrix.

Alternatively, the posterior probability calculation unit 72 may calculate the posterior probabilities of the dictionary matrix, the selection matrix, and the generation target matrix, assuming that the selection matrix is generated by the Indian buffet process and that the training matrix and the generation target matrix are probabilistically generated from the product of the dictionary matrix and the selection matrix.

The above exemplary embodiments of the present invention can also be described as the following supplementary notes, but are not necessarily limited to the following.

### (Supplementary Note 1)

A supervised infinite binary matrix generation device comprising:

a data input unit configured to input a dictionary matrix obtained by collecting binary row vectors of a plurality of types of patterns, a binary selection matrix having one “1” in each row, and a binary training matrix; and

a posterior probability calculation unit configured to calculate posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

### (Supplementary Note 2)

The supervised infinite binary matrix generation device according to supplementary note 1, wherein

the posterior probability calculation unit is configured to calculate the posterior probabilities of the dictionary matrix and the selection matrix, assuming that the training matrix is generated using different probability distributions depending on whether each element of a matrix of the product of the dictionary matrix and the selection matrix is 1 or 0.

### (Supplementary Note 3)

A supervised infinite binary matrix generation device comprising:

a data input unit configured to input a dictionary matrix obtained by collecting binary row vectors of a plurality of types of patterns, a selection matrix represented by unconstrained binary values, a binary training matrix, and a binary generation target matrix; and

a posterior probability calculation unit configured to calculate posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

### (Supplementary Note 4)

The supervised infinite binary matrix generation device according to supplementary note 3, wherein

the posterior probability calculation unit is configured to calculate the posterior probabilities of the dictionary matrix, the selection matrix, and the generation target matrix, assuming that the training matrix is generated using different probability distributions depending on whether each element of the generation target matrix is 1 or 0.

### (Supplementary Note 5)

A supervised infinite binary matrix generation device comprising:

a data input unit configured to input a dictionary matrix obtained by collecting binary row vectors of a plurality of types of patterns, a selection matrix represented by unconstrained binary values, a binary training matrix, and a binary generation target matrix; and

a posterior probability calculation unit configured to calculate posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

### (Supplementary Note 6)

A supervised infinite binary matrix generation method comprising:

performing, by a computer including a data input unit configured to input a dictionary matrix obtained by collecting binary row vectors of a plurality of types of patterns, a binary selection matrix having one “1” in each row, and a binary training matrix, posterior probability calculation processing of calculating posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

### (Supplementary Note 7)

The supervised infinite binary matrix generation method according to supplementary note 6, wherein

the posterior probability calculation processing includes calculating, by the computer, the posterior probabilities of the dictionary matrix and the selection matrix, assuming that the training matrix is generated using different probability distributions depending on whether each element of a matrix of the product of the dictionary matrix and the selection matrix is 1 or 0.

### (Supplementary Note 8)

A supervised infinite binary matrix generation method comprising:

performing, by a computer including a data input unit configured to input a dictionary matrix obtained by collecting binary row vectors of a plurality of types of patterns, a selection matrix represented by unconstrained binary values, a binary training matrix, and a binary generation target matrix, posterior probability calculation processing of calculating posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

### (Supplementary Note 9)

The supervised infinite binary matrix generation method according to supplementary note 8, wherein

the posterior probability calculation processing includes calculating, by the computer, the posterior probabilities of the dictionary matrix, the selection matrix, and the generation target matrix, assuming that the training matrix is generated using different probability distributions depending on whether each element of the generation target matrix is 1 or 0.

### (Supplementary Note 10)

A supervised infinite binary matrix generation method comprising:

performing, by a computer including a data input unit configured to input a dictionary matrix obtained by collecting binary row vectors of a plurality of types of patterns, a selection matrix represented by unconstrained binary values, a binary training matrix, and a binary generation target matrix, posterior probability calculation processing of calculating posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

### (Supplementary Note 11)

A supervised infinite binary matrix generation program to be mounted in a computer including a data input unit configured to input a dictionary matrix obtained by collecting binary row vectors of a plurality of types of patterns, a binary selection matrix having one “1” in each row, and a binary training matrix, the supervised infinite binary matrix generation program causing the computer to execute:

posterior probability calculation processing of calculating posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

### (Supplementary Note 12)

The supervised infinite binary matrix generation program according to supplementary note 10, wherein

the program causes the computer to calculate, in the posterior probability calculation processing, the posterior probabilities of the dictionary matrix and the selection matrix, assuming that the training matrix is generated using different probability distributions depending on whether each element of a matrix of the product of the dictionary matrix and the selection matrix is 1 or 0.

### (Supplementary Note 13)

A supervised infinite binary matrix generation program to be mounted in a computer including a data input unit configured to input a dictionary matrix obtained by collecting binary row vectors of a plurality of types of patterns, a selection matrix represented by unconstrained binary values, a binary training matrix, and a binary generation target matrix, the supervised infinite binary matrix generation program causing the computer to execute:

performing posterior probability calculation processing of calculating posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

### (Supplementary Note 14)

The supervised infinite binary matrix generation program according to supplementary note 13, wherein

the program causing the computer to calculate, in the posterior probability calculation processing, the posterior probabilities of the dictionary matrix, the selection matrix, and the generation target matrix, assuming that the training matrix is generated using different probability distributions depending on whether each element of the generation target matrix is 1 or 0.

### (Supplementary Note 15)

A supervised infinite binary matrix generation program to be mounted in a computer including a data input unit configured to input a dictionary matrix obtained by collecting binary row vectors of a plurality of types of patterns, a selection matrix represented by unconstrained binary values, a binary training matrix, and a binary generation target matrix, the supervised infinite binary matrix generation program causing the computer to execute:

performing posterior probability calculation processing of calculating posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

The present invention has been described with reference to the exemplary embodiments, but is not limited to the above exemplary embodiments. Various changes that can be understood by those skilled in the art within the scope of the present invention can be made to the configurations and details of the present invention.

### INDUSTRIAL APPLICABILITY

The present invention is suitably applied to generation of a binary matrix allowing humans to understand the meaning of each dimension.

### REFERENCE SIGNS LIST

100, 200 Supervised infinite binary matrix generation device
110, 210 Inquiry unit
120, 220 Data input unit
130, 230 Data storage unit
140, 240 Supervised M_{l,k} posterior probability calculation unit
150, 250 Unsupervised M_{l,k} posterior probability calculation unit
160, 260 Matrix M new column addition probability calculation unit
170 Supervised Cᵢ⁽¹⁾ posterior probability calculation unit
180 Unsupervised Cⱼ⁽²⁾ posterior probability calculation unit
190, 320 Posterior probability calculation unit
270 Supervised C_{i,l}⁽¹⁾ posterior probability calculation unit
280 Unsupervised C_{j,l}⁽²⁾ posterior probability calculation unit
290 Matrix C new column addition probability calculation unit
300 Supervised Z_{i,k} posterior probability calculation unit
310 Unsupervised Z_{i,k} posterior probability calculation unit
400 Skill estimation device
410 Matrix Q estimation unit
420 Matrix R estimation unit
430 Matrix Z estimation unit
440 θ estimation unit

What is claimed is:

1. A supervised infinite binary matrix generation device comprising:
a data input unit configured to input a dictionary matrix obtained by collecting binary row vectors of a plurality of types of patterns, a binary selection matrix having one “1” in each row, and a binary training matrix; and
a posterior probability calculation unit configured to calculate posterior probabilities of the dictionary matrix and the selection matrix, based on a generation process in which the dictionary matrix is generated by an Indian buffet process, a generation process in which the selection matrix is generated by a Dirichlet process, and a generation process in which the training matrix is probabilistically or deterministically generated from a part of a product of the dictionary matrix and the selection matrix.

2. The supervised infinite binary matrix generation device according to claim 1, wherein
the posterior probability calculation unit is configured to calculate the posterior probabilities of the dictionary matrix and the selection matrix, assuming that the training matrix is generated using different probability distributions depending on whether each element of a matrix of the product of the dictionary matrix and the selection matrix is 1 or 0.

3. A supervised infinite binary matrix generation device comprising:
a data input unit configured to input a dictionary matrix obtained by collecting binary row vectors of a plurality of types of patterns, a selection matrix represented by unconstrained binary values, a binary training matrix, and a binary generation target matrix; and
a posterior probability calculation unit configured to calculate posterior probabilities of the dictionary matrix, the selection matrix, and the generation target matrix, assuming that the selection matrix is generated by an Indian buffet process, that the generation target matrix is probabilistically generated from a product of the dictionary matrix and the selection matrix, and that the training matrix is probabilistically generated from a part of the generation target matrix.

4. The supervised infinite binary matrix generation device according to claim 3, wherein
the posterior probability calculation unit is configured to calculate the posterior probabilities of the dictionary matrix, the selection matrix, and the generation target matrix, assuming that the training matrix is generated using different probability distributions depending on whether each element of the generation target matrix is 1 or 0.

5. A supervised infinite binary matrix generation device comprising:
a data input unit configured to input a dictionary matrix obtained by collecting binary row vectors of a plurality of types of patterns, a selection matrix represented by unconstrained binary values, a binary training matrix, and a binary generation target matrix; and
a posterior probability calculation unit configured to calculate posterior probabilities of the dictionary matrix, the selection matrix, and the generation target matrix, assuming that the selection matrix is generated by an Indian buffet process, and that the training matrix and the generation target matrix are probabilistically generated from a product of the dictionary matrix and the selection matrix.

6.-15. (canceled)
